(19) United States
(12) Patent Application Publication
(10) Pub. No.: US 2025/0266472 A1
(43) Pub. Date: Aug. 21, 2025

(54) POWER GENERATOR TEMPERATURE REGULATION, AND ASSOCIATED SYSTEMS, DEVICES, MOBILE UNITS, AND METHODS

(71) Applicant: LiveView Technologies, LLC, American Fork, UT (US)

(72) Inventors: Riley Hiatt, American Fork, UT (US); Jordan Smith, American Fork, UT (US)

(21) Appl. No.: 18/582,002

(22) Filed: Feb. 20, 2024

(51) Int. Cl. H01M 8/04014; H01M 8/04007; H01M 8/0432; H01M 8/04701; H01M 8/04746

(52) U.S. Cl. CPC H01M 8/04014; H01M 8/04067; H01M 8/0432; H01M 8/04701; H01M 8/04768; H01M 2250/30

(57) ABSTRACT

Various embodiments relate to systems including a mobile surveillance unit. A system may include a mobile surveillance unit that includes at least one controller, a fuel cell generator coupled to the controller, and a temperature regulator proximate the fuel cell generator. The temperature regulator may include a temperature sensor for sensing a temperature in or near the fuel cell generator and a fan system including a fan. The at least one controller may be configured to receive a signal from the temperature sensor indicative of the sensed temperature. The controller may also be configured to generate a control signal to turn the fan on based on the sensed temperature being greater than or equal to a threshold temperature. Associated methods and mobile surveillance units are also disclosed.

### TECHNICAL FIELD

This disclosure relates generally to temperature regulation and, more specifically, to power generator temperature regulation, and to related devices, systems, mobile units, and methods.

### BACKGROUND

Mobile units, such as mobile surveillance units, which may include a number of sensors and/or a number of output devices, may be positioned in a remote environment for providing surveillance and/or security in and/or around the remote environment.

In some applications, a mobile unit may include one or more solar panels for providing power to one or more devices of the mobile unit. However, as will be appreciated, solar energy has various limitations due to the lack of sunlight as a result of, for example, storms and/or overcast skies, shorter daylight hours (e.g., during winter), and/or other obstacles that may prevent sunlight radiation from reaching a solar panel.

Other power generators, such as fuel cell power generators, may also be used with mobile units. However, due to extreme and ever-changing weather and temperature conditions in an environment wherein a mobile unit is positioned, regulating a power generator of a mobile unit for optimal performance has proven to be challenging.

### BRIEF SUMMARY

At least one embodiment of the disclosure includes a system including a mobile surveillance unit. The system may include a mobile surveillance unit comprising at least one controller and a fuel cell generator coupled to the controller. The mobile surveillance unit may also include a temperature regulator proximate the power generator. The temperature regulator may include a temperature sensor coupled to the controller and configured for sensing a temperature near the power generator, and a fan system including a fan. The controller may be configured to receive a signal from the temperature sensor indicative of the sensed temperature and generate a control signal to turn the fan on based on the sensed temperature being greater than or equal to a threshold temperature.

Another embodiment includes a method of operating a mobile surveillance unit. The method may include generating power via a fuel cell generator coupled to a mobile surveillance unit and positioned within a trailer box of the mobile surveillance unit. The method may also include providing at least some of the generated power to one or more devices of the mobile surveillance unit. Further, the method may include sensing a temperature proximate the fuel cell generator. Also, the method may include causing a fan proximate the fuel cell generator to turn on to cause at least some air in the trailer box to exit the trailer box responsive to the sensed temperature being greater than or equal to a threshold temperature.

Other embodiments may include a mobile surveillance unit. The mobile surveillance unit may include a trailer, a storage box coupled to the trailer, a mast coupled to the trailer, and a head unit coupled to the mast. The head unit may include a controller, a number of sensors, and a number of output devices. The storage box may include at least one battery, a power generator, and a temperature regulator proximate the power generator. The temperature regulator may include a temperature sensor for sensing a temperature proximate the power generator, and a fan system including a fan. The controller may be configured to receive a signal from the temperature sensor indicative of the sensed temperature. The controller may also be configured to generate a control signal to control operation of the fan system based on the sensed temperature.

### BRIEF DESCRIPTION OF THE DRAWINGS

FIG. 1 depicts an example system including a mobile unit, in accordance with one or more embodiments of the disclosure.

FIGS. 2A-2C illustrate examples of a mobile unit, in accordance with various embodiments of the disclosure.

FIG. 3 is a block diagram illustration of a system including a mobile unit, in accordance with various embodiments of the disclosure.

FIG. 4 depicts an example system including a power generator and fan within a housing, in accordance with various embodiments of the disclosure.

FIG. 5 depicts an example system including a power generator, a portion of an example housing, and an example fan system, according to various embodiments of the disclosure.

FIG. 6A illustrates an example fan system including a fan, in accordance with various embodiments of the disclosure.

FIG. 6B is another illustration of an example fan system including a fan, in accordance with various embodiments of the disclosure.

FIGS. 7A and 7B illustrate a portion of an example storage box including a power generator, fuel for the power generator, and a number of batteries, according to various embodiments of the disclosure.

FIG. 8 depicts an example storage box for holding a power generator, in accordance with various embodiments of the disclosure.

FIG. 9 depicts an example system including a mobile unit, in accordance with various embodiments of the disclosure.

FIG. 10 depicts an example system including a mobile unit, a server, and one or more devices, in accordance with various embodiments of the disclosure.

FIG. 11 is a flowchart illustrating an example method of operating a mobile unit, according to various embodiments of the disclosure.

### DETAILED DESCRIPTION

Referring in general to the accompanying drawings, various embodiments of the present disclosure are illustrated to show example embodiments related to regulating temperature of and/or near a power generator. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

As will be appreciated, some devices (e.g., electronic devices) may function properly in one temperature range but not in another temperature range. More specifically, for example, in some conventional systems, a power generator (e.g., a fuel cell generator) system may be configured to operate in one extreme temperature condition (i.e., either hot or cold temperatures), but not both. As will also be appreciated, it may be ideal for a device (e.g., a mobile unit including a power generator) to operate in a range of extreme temperature environments (e.g., hot conditions during summer months, cold/freezing conditions during winter months). Also, due to its mobile nature, a single mobile unit may be positioned in one location (e.g., southern Arizona) during one time period (e.g., summer) and another location (e.g., Minnesota) during another time period (e.g., winter). Various embodiments disclosed herein may enable a device (e.g., a mobile unit including a power generator) to function properly over a wide range of temperatures.

As will further be appreciated, various embodiments of the disclosure, as described more fully herein, provide a technical solution to one or more problems that arise from technology that could not reasonably be performed by a person, and various embodiments disclosed herein are rooted in computer technology in order to overcome the problems and/or challenges described below. Further, at least some embodiments disclosed herein may improve computer-related technology by allowing computer performance of a function not previously performable by a computer.

Embodiments of the disclosure will now be explained with reference to the accompanying drawings.

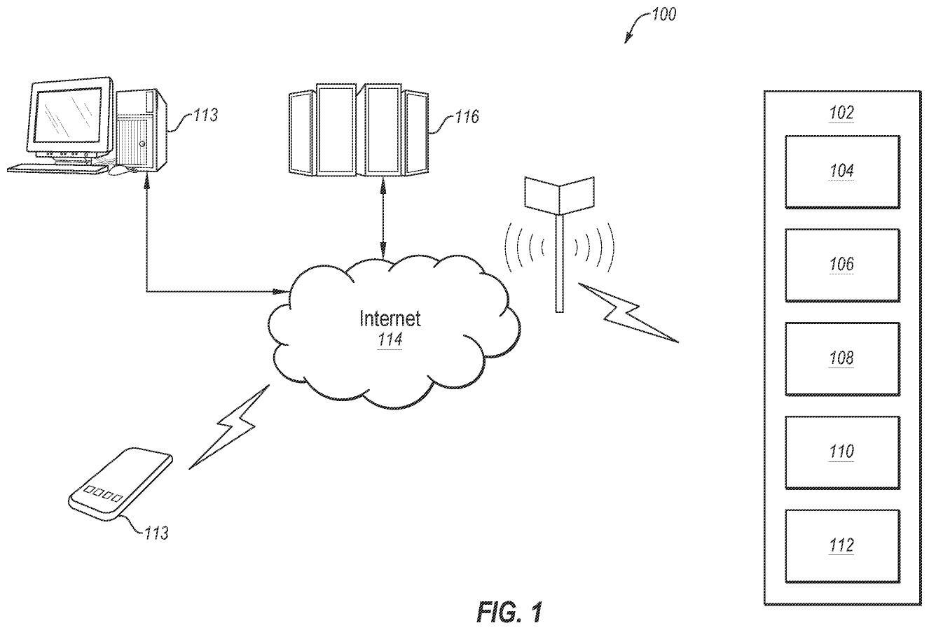

FIG. 1 illustrates an example system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors (e.g., cameras, weather sensors, motion sensors, noise sensors, chemical sensors, without limitation) 104 and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., two-way public address (PA) speaker systems), any other suitable output device (e.g., a digital display), or any combination thereof.

In some embodiments, unit 102 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation of unit 102, storage device 108 may continuously record data (e.g., video, images, i-frames, and/or other data) captured by one or more sensors 104 (e.g., cameras, lidar, radar, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Moreover, although not shown in FIG. 1, unit 102 may include one or more additional devices including, but not limited to, one or more microphones, one or more solar panels, one or more power generators (e.g., fuel cell generators), or any combination thereof. Unit 102 may also include a communication device (e.g., a modem (e.g., a cellular modem, a satellite modem, a Wi-Fi modem, etc.)) 112 that may comprise any suitable and known communication device, which may be coupled to sensors 104, output devices 106, storage device 108, and/or computer 110 via wired connections, wireless connections, or a combination thereof. In some embodiments, communication device 112 may include one or more radios and/or one or more antennas.

System 100 may further include one or more electronic devices 113, which may comprise, for example only, a mobile device (e.g., mobile phone, tablet, etc.), a desktop computer, or any other suitable electronic device including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via the Internet 114.

According to various embodiments of the disclosure, unit 102 may be within a first location (a “remote location,” “camera location” or a “unit location”), and server 116 may be within a second location, remote from the first location. In addition, each electronic device 113 may or may not be remote from unit 102 and/or server 116. As will be appreciated by a person having ordinary skill in the art, system 100 may be modular, expandable, and/or scalable.

As noted above, in some embodiments, unit 102 may include a mobile unit (e.g., a mobile security/surveillance unit). In these and other embodiments, unit 102 may include a portable trailer (not shown in FIG. 1), a storage box (e.g., including one or more batteries and/or a power generator) (not shown in FIG. 1), and a mast (not shown in FIG. 1) coupled to a head unit (e.g., including, for example, one or more cameras, one or more lights, one or more speakers, and/or one or more microphones) (not shown in FIG. 1). According to various examples, in addition to sensors (e.g., sensors 104) and output devices (e.g., output devices 106), a head unit of unit 102 may include and/or may be coupled to storage device 108, computer 110, and/or communication device 112.

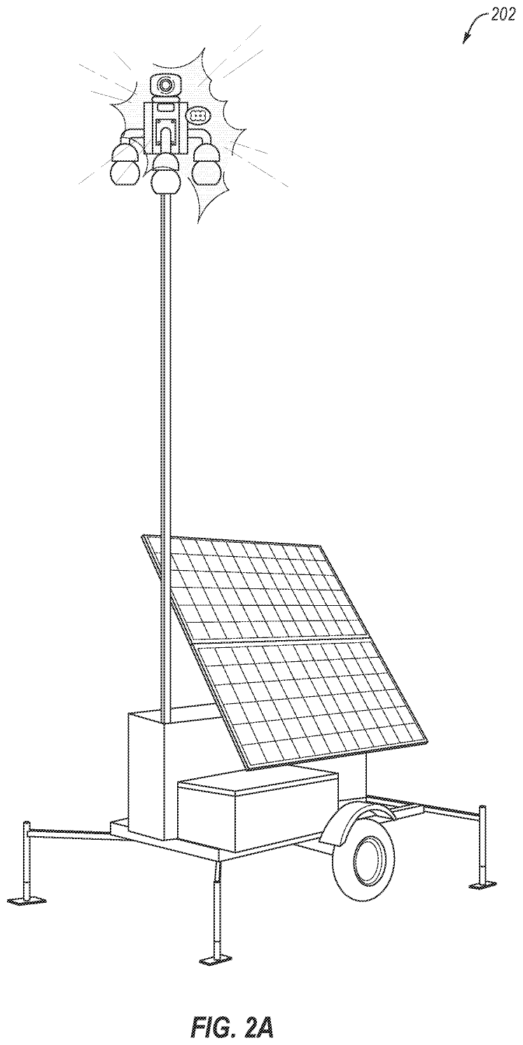

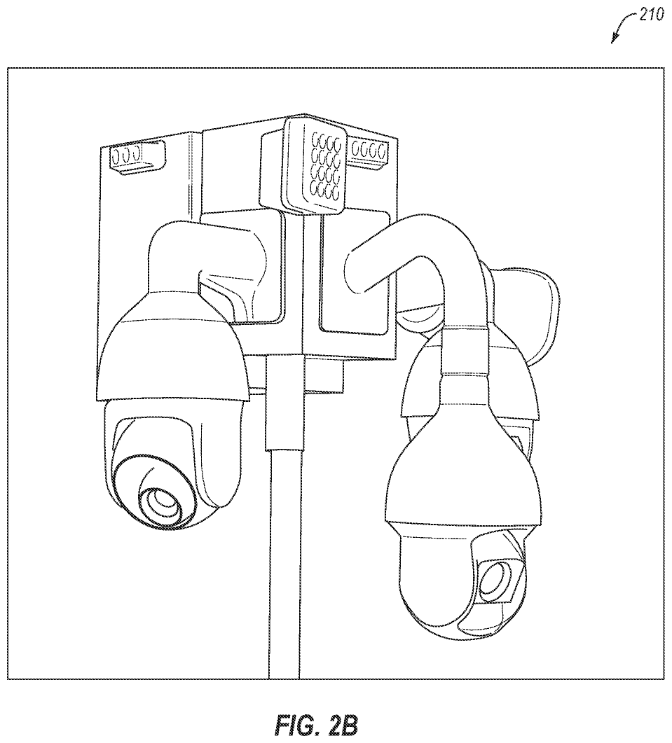

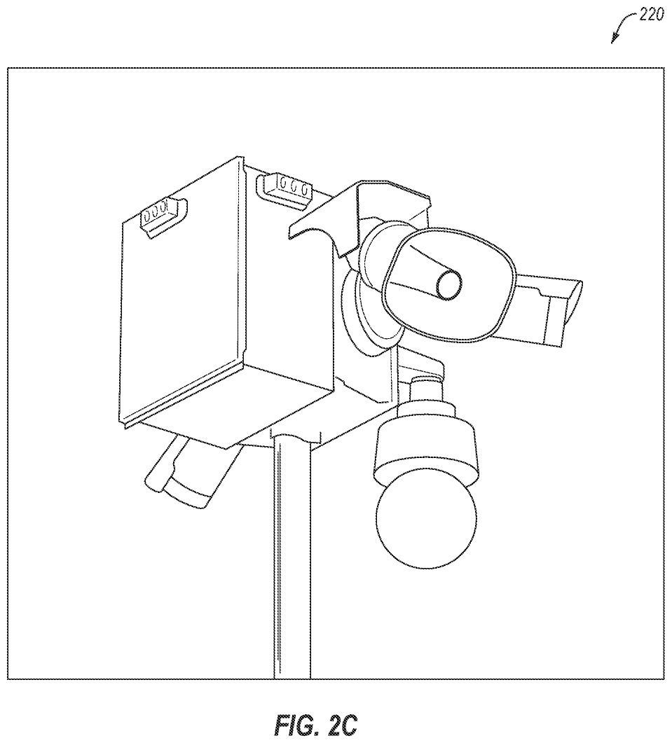

Non-limiting examples of unit 102 are shown in FIGS. 2A-2C. More specifically, FIG. 2A illustrates a mobile unit 202 including a trailer, a storage box, a mast, and a head unit; FIG. 2B illustrates a head unit 210 (i.e., of a mobile unit) including a number of lights, a number of cameras, and a speaker; and FIG. 2C is another depiction of a head unit 220 (i.e., of a mobile unit) including a number of lights, a number of cameras, and a speaker. As an example, a mobile unit may be configured to be positioned in an environment (e.g., a parking lot, a roadside location, a construction zone, a concert venue, a sporting venue, a school campus, without limitation).

According to various embodiments, a mobile unit (e.g., unit 102) may include one or more power generators (e.g., one or more fuel cell generators, such as one or more EFOY® fuel cells made by SFC Energy AG of Brunnthal, Germany). In some examples, a power generator, such as a fuel cell generator, may be used to provide power to a mobile unit (e.g., in the event sufficient power is not generated via one or more solar panels).

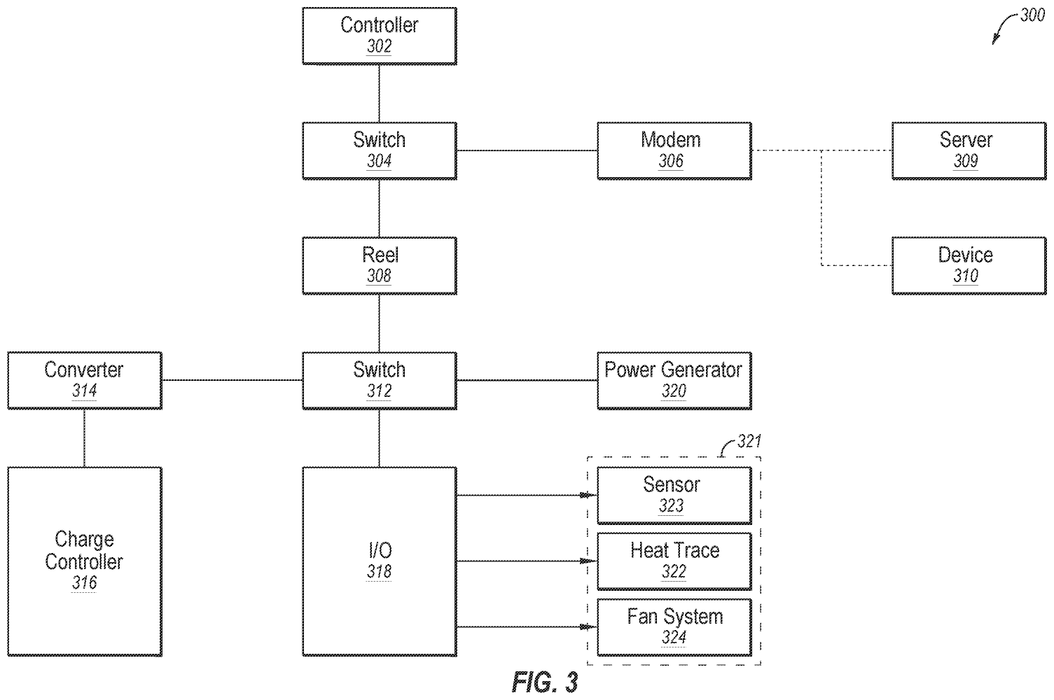

FIG. 3 includes a block diagram of an example system 300, in accordance with various embodiments of the disclosure. System 300 includes a controller 302, a switch 304, a modem 306, and a reel 308, which may include a power and/or Ethernet reel. For example, in some embodiments, controller 302, switch 304, and modem 306 may be positioned within a head unit (e.g., head unit 210 and/or head unit 220) of a mobile unit, and reel 308, which may be part of the mobile unit, may be configured to provide power and/or Ethernet to and/or from one or more components of the head unit. As will be appreciated, modem 306 may be configured to enable communication with a remote device and/or system (e.g., remote from a mobile unit), such as one or more servers 309 (e.g., server 116 of FIG. 1) and/or devices 310 (e.g., electronic device 113 of FIG. 1).

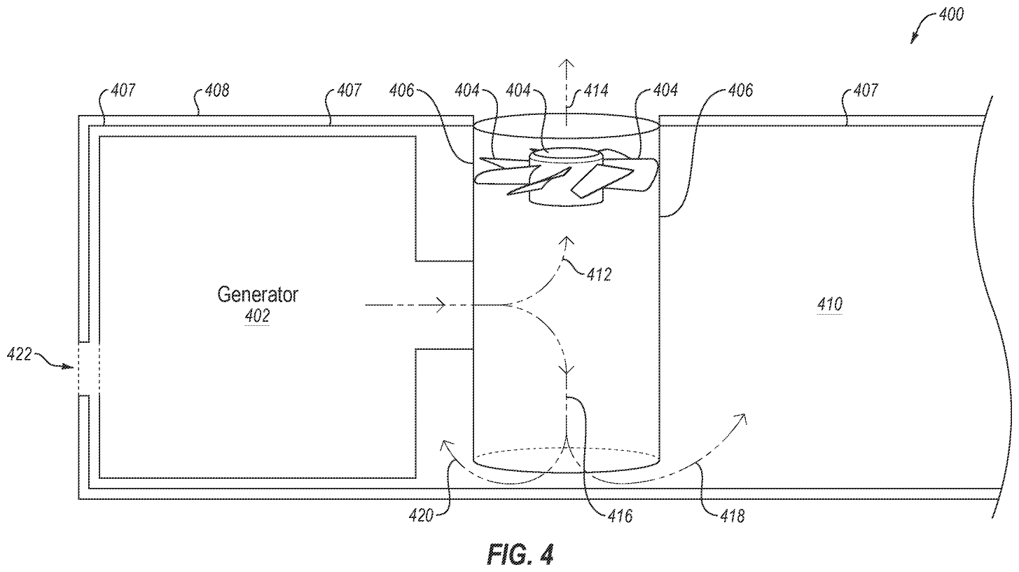

System 300 may further include a switch 312, a converter (e.g., Ethernet to serial converter) 314, a charge controller 316, and an I/O device 318. For example, switch 312, charger controller 316, and/or I/O device 318 may be positioned within a box (e.g., a storage box coupled to a base of the mobile unit) (e.g., a box 408 of FIG. 4) of a mobile unit. In addition, system 300 may include one or more power generators 320 and a temperature regulator system 321, which may include a heat trace 322, a temperature sensor 323, and a fan system 324. For example, fan system 324 may include a fan and a housing. For example, power generator(s) 320 and temperature regulator system 321 may be positioned within a box of a mobile unit (e.g., a storage box coupled to a base of the mobile unit). In some embodiments, temperature sensor 323 may be within (e.g., part of) power generator 320. In other embodiments, temperature sensor 323 may be a standalone temperature sensor.

According to various embodiments, temperature sensor 323 may be configured to sense a temperature (e.g., continuously, periodically, and/or in response to a trigger) in or near power generator 320, and data indicative thereof may be received by controller 302, which may compare the sensed temperature to one or more threshold temperatures. Further, based on the sensed temperature in or near power generator 320, a signal may be conveyed (e.g., from controller 302) to control a fan of fan system 324. For example, if the sensed temperature is equal to or greater than a threshold temperature, a fan of fan system 324 may be turned on such that at least some air around power generator 320 is pulled (or pushed) out of an enclosure (e.g., a housing) including power generator 320 (i.e., and toward an exit vent). As another example, if the sensed temperature is less than the threshold temperature (or another temperature), a fan of fan system 324 may be turned off (or remain off) such that at least some air around power generator 320 remains in or near power generator 320. As another example, rather than turning the fan off, a rotation of the fan may be such that air is blown away from an exit vent (e.g., recirculated within an enclosure including power generator 320). Further, in some embodiments, based on the sensed temperature, a speed of the fan may be controlled (e.g., higher fan speed in response to a higher sensed temperature, a lower fan speed in response to a lower sensed temperature, etc.).

As noted above, a system (e.g., system 300) may include a power generator (e.g., power generator 320) and a fan system (e.g., fan system 324) including a fan within a fan housing positioned proximate a power generator. For example, with reference to FIG. 4, a system 400, including a power generator 402 and a fan system including a fan 404 within a housing 406, in accordance with various embodiments, is shown. According to various embodiments, power generator 402 and housing 406 may be positioned within a housing 407, which may be positioned within a box 408 (also referred to herein as a “storage box,” “enclosure,” or a “container”). In some examples, box 408 may be coupled to a base (e.g., of trailer of a mobile unit). Box 408 may include additional space 410 for housing additional devices, such as one or more batteries, fuel (e.g., for a fuel cell), a controls enclosure, and/or other devices and/or equipment.

During a contemplated operation of system 400, a sensor (not shown in FIG. 4; e.g., temperature sensor 323 of FIG. 3) may sense a temperature (e.g., continuously or periodically) in and/or near power generator 402, and, in response to the sensed temperature being equal to or greater than a threshold temperature (e.g., 100 degrees Fahrenheit, 105 degrees Fahrenheit, 108 degrees Fahrenheit, or any other temperature), fan 404 may be turned on such that air in and/or near power generator 402 may be pulled away from power generator 402 along path 412 and out of box 408, as indicated by arrow 414. For example, blades of fan 404 may rotate in a direction such that air is moved away from power generator 402 along path 412 and out of box 408, as indicated by arrow 414. As will be appreciated, in this example, air (e.g., cooler air) may be moved into box 408 via opening 422. Further, if fan 404 is on and the sensed temperature drops below a temperature (e.g., the threshold temperature or another temperature), fan 404 may be turned off (e.g., such that at least some of the air remains in box 408). In other embodiments, if the sensed temperature drops below a temperature (e.g., the threshold temperature or another temperature), fan 404 may be turned on (or remain on) and the blades of fan 404 may rotate in a direction such that air flows along path 416/418 into space 410 and/or back toward generator 402 via path 416/420. Causing air (e.g., warm air) to remain in box may be beneficial (e.g., in cold temperatures), such as providing heat around one or more batteries and/or other components.

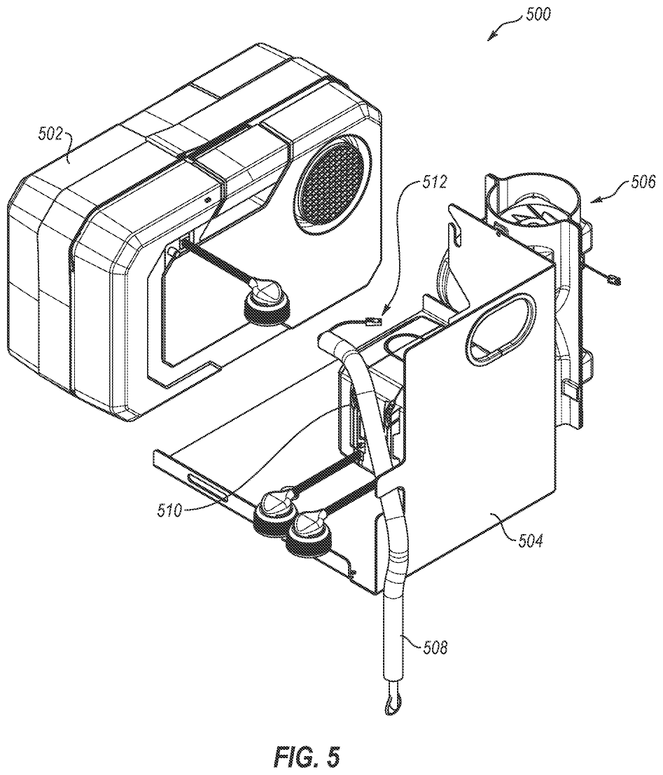

FIG. 5 depicts an example system 500, according to various embodiments. System 500 includes a fuel cell generator 502, a housing 504 (i.e., for coupling to fuel cell generator 502), and a fan system 506. FIG. 5 further depicts an exhaust drain tube 508, a fuel manager 510, and a heat trace 512.

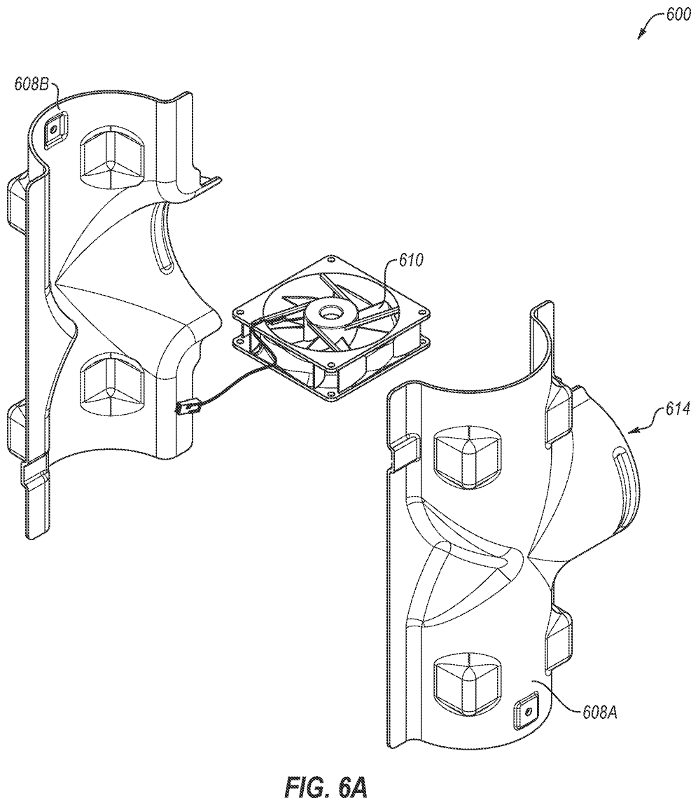

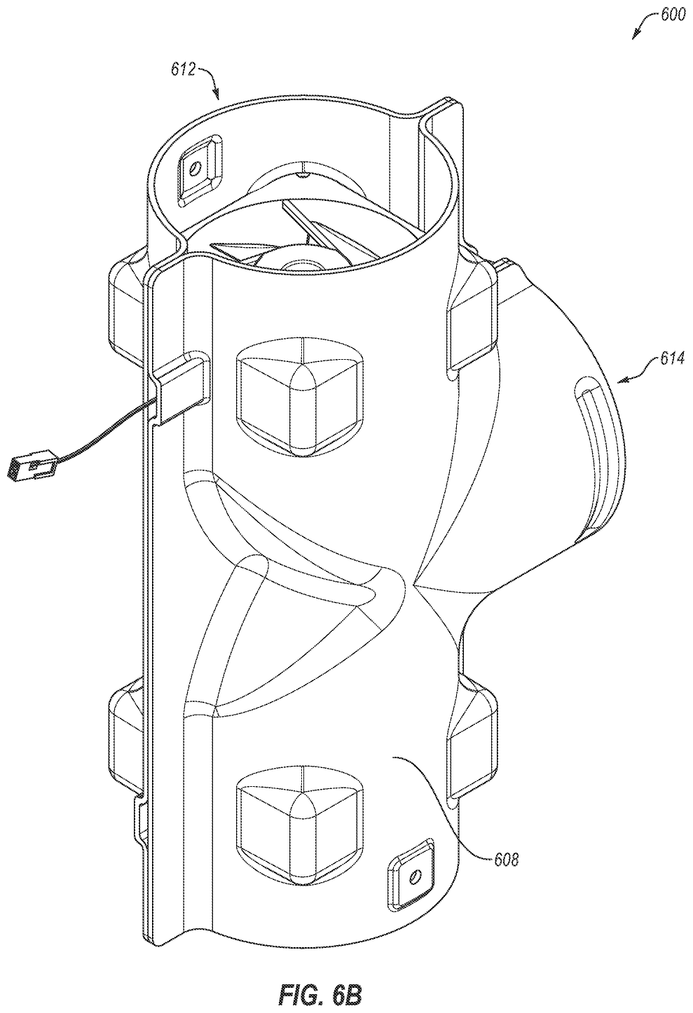

FIGS. 6A and 6B illustrate a fan system 600, according to various embodiments of the disclosure. More specifically, FIG. 6A depicts fan system 600 in a disassembled state, showing housing portions 608A and 608B and a fan 610. FIG. 6B depicts fan system 600 in an assembled state. As shown in each of FIGS. 6A and 6B, housing 608 includes an opening 612 (e.g., for enabling air to flow out of, for example, box 408, as indicated by arrow 414 shown in FIG. 4). Housing 608 further includes an opening 614 to enable air in and/or near power generator 402 to flow away from power generator 402 along path 412 and/or path 416, as shown in FIG. 4.

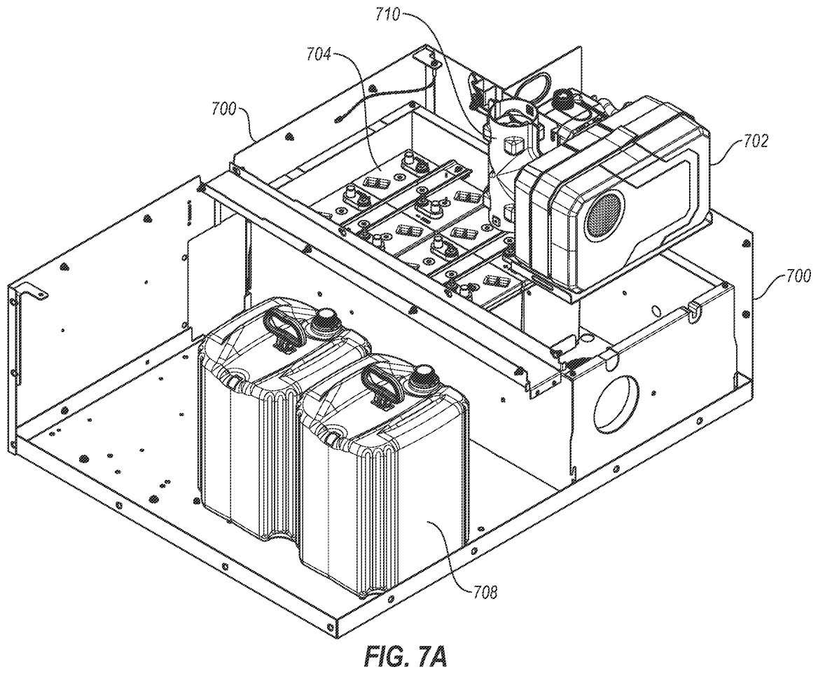

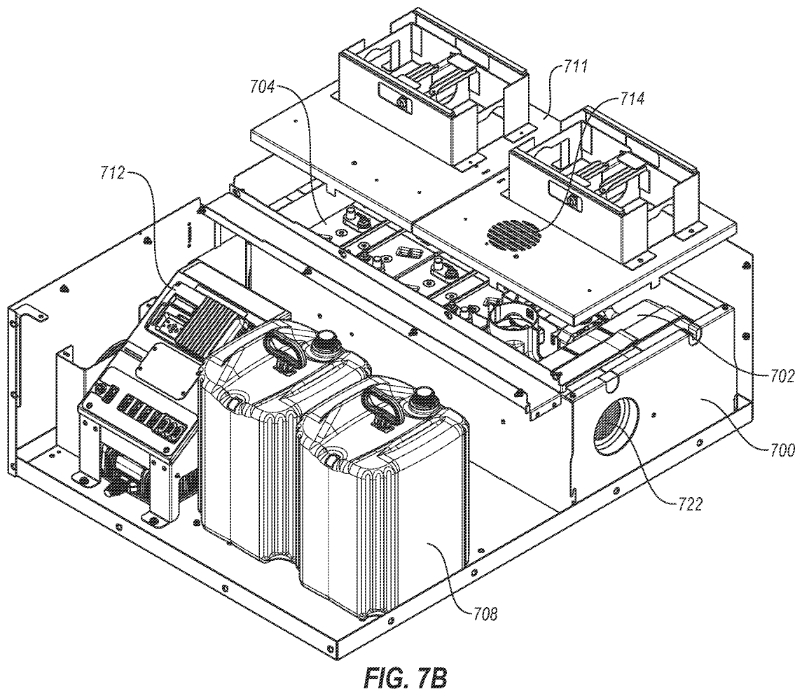

FIG. 7A depicts a portion of an example housing 700, a fuel cell generator 702, batteries 704, fuel cell cartridges 708, and a fan housing 710 posited proximate fuel cell generator 702. FIG. 7B is another illustration of an example housing 700, fuel cell generator 702, batteries 704, fuel cell cartridges 708, and a portion of a cover 711, which may include any suitable material (e.g., foam). Cover 711 may include a vent 714, which may enable air to flow out of housing 700 (e.g., as indicated by arrow 414 shown in FIG. 4). Also, housing 700 may include a vent 722, which may enable air to flow into housing 700 (e.g., via opening 422 of FIG. 4). Other devices (e.g., control enclosure 712) are also shown in FIG. 7B.

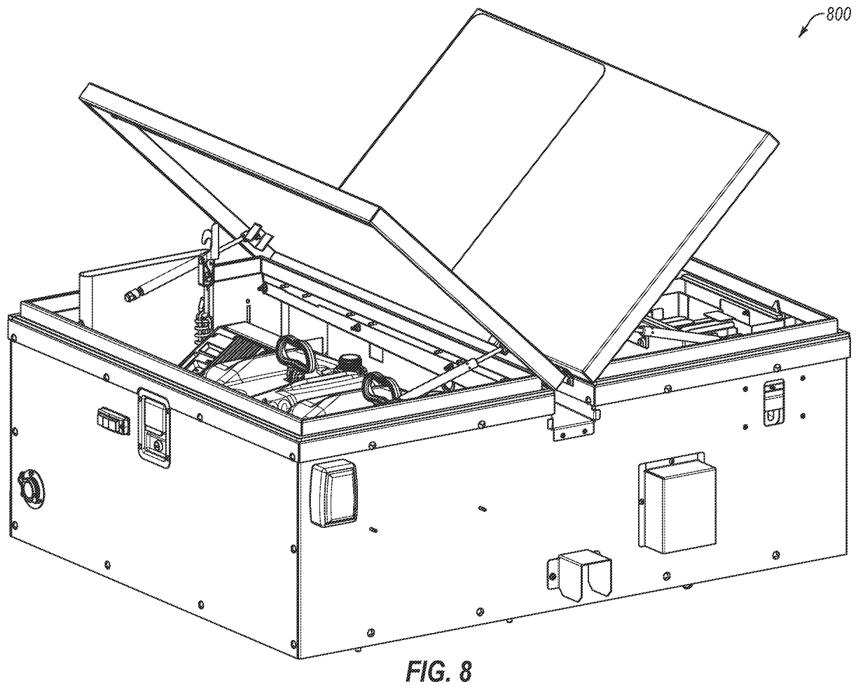

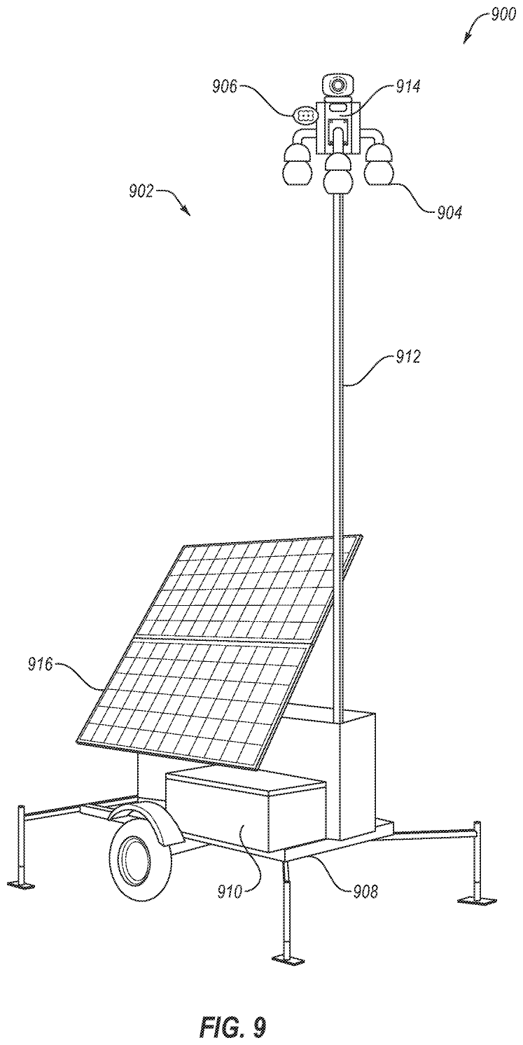

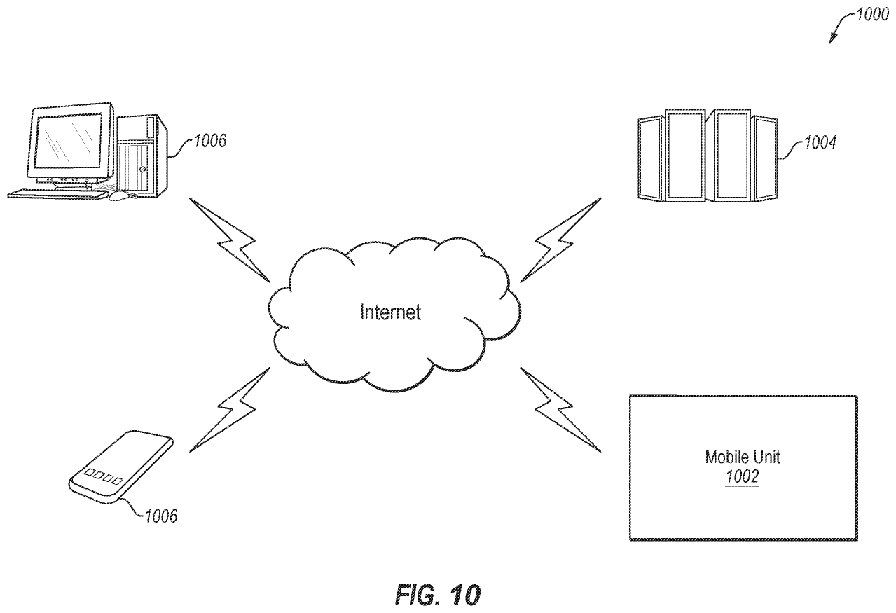

FIG. 8 depicts an example box 800, according to various embodiments of the disclosure. For example, box 800 may be sized and configured to receive at least one power generator (e.g., power generator 320 of FIG. 3) and a temperature regulator (e.g., temperature regulator system 321 of FIG. 3), which may include a temperature sensor and a fan system (e.g., fan system 324 of FIG. 3 and/or fan system 600 of FIGS. 6A and 6B). Further, in some examples, box 800 may be part of a mobile unit (e.g., unit 102 of FIG. 1, unit 202 of FIG. 2A, a unit 902 of FIG. 9, and/or a mobile unit 1002 of FIG. 10). As a more specific example, box 800 may be coupled to a trailer (e.g., a trailer 908 of FIG. 9) of a mobile surveillance unit.

FIG. 9 depicts another example system 900 including a unit 902, in accordance with various embodiments of the disclosure. Unit 902, which may also be referred to herein as a “mobile unit,” a “mobile security unit,” a “live unit,” or a “physical unit,” may be configured to be positioned in an environment (e.g., a parking lot, a roadside location, a construction zone, a concert venue, a sporting venue, a school campus, without limitation). In some embodiments, unit 902 may include one or more sensors 904 (e.g., cameras, weather sensors, motion sensors, noise sensors, without limitation) and one or more output devices 906 (e.g., lights, speakers, electronic displays, without limitation). Unit 902 may also include at least one storage device (e.g., internal flash media, a network attached storage device, or any other suitable electronic storage device), which may be configured for receiving and storing data (e.g., video, images, audio, without limitation) captured by one or more sensors of unit 902. According to some embodiments, unit 902 may include or may be part of at least a portion of system 100 of FIG. 1, system 300 of FIG. 3, system 400 of FIG. 4, system 500 of FIG. 5, system 600 of FIGS. 6A and 6B, housing 700 of FIG. 7, and/or box 800 of FIG. 8.

In some embodiments, unit 902 may include a mobile security unit. In these and other embodiments, unit 902 may include a portable trailer 908, a storage box 910 (e.g., box 800 of FIG. 8), and a mast 912 coupled to a head unit 914, which may include, for example, one or more batteries, one or more cameras, one or more lights, one or more speakers, and/or one or more microphones. According to some embodiments, a first end of mast 912 may be proximate storage box 910 and a second, opposite end of mast 912 may be proximate, and possibly adjacent, head unit 914. More specifically, in some embodiments, head unit 914 may be coupled to mast 912 at an end opposite an end of mast 912 proximate storage box 910.

In some examples, unit 902 may include one or more primary batteries (e.g., within storage box 910) and one or more secondary batteries (e.g., within head unit 914). In these embodiments, a primary battery positioned in storage box 910 may be coupled to one or more loads and/or a secondary battery positioned within head unit 914 via, for example, a cord reel (e.g., reel 308 of FIG. 3 (e.g., configured for Ethernet and/or power)).

In some embodiments, unit 902 may also include one or more solar panels 916, which may provide power to one or more batteries of unit 902. More specifically, according to some embodiments, one or more solar panels 916 may provide power to a primary battery within storage box 910. As noted herein, unit 902 may also include one or more additional power sources, such as one or more generators (e.g., fuel cell generators), which may be positioned within storage box 910.

FIG. 10 depicts a system 1000, in accordance with various embodiments of the disclosure. System 1000 includes a mobile unit 1002, a server 1004, and one or more devices 1006. In one non-limiting example, mobile unit 1002 includes mobile unit 902 (see FIG. 9), server 1004 may include a cloud server or any other server, and device(s) 1006 may include an electronic device, such as a user device (e.g., mobile phone, tablet, etc.), a desktop computer, or any other suitable electronic device (e.g., including a display). According to various embodiments, each of server 1004 and device(s) 1006 may be remote from mobile unit 1002.

According to various embodiments of the present disclosure, mobile unit 1002, which includes a modem (e.g., communication device 112 of FIG. 1), may be within a first location (a “camera location” or a “remote location”), and server 1004 may be within a second location, remote from the camera location. In addition, in at least some examples, electronic device 1006 may be remote from the camera location and/or server 1004. As will be appreciated by a person having ordinary skill in the art, system 1000 is modular, expandable, and scalable.

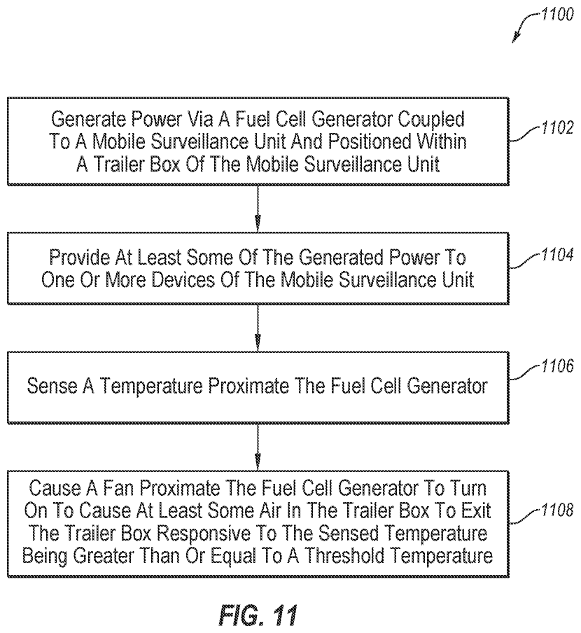

FIG. 11 is a flowchart of an example method 1100 of operating a mobile surveillance unit, according to various embodiments of the disclosure. More specifically, for example, method 1100 may be related to regulating temperature proximate at least one power generator of a mobile surveillance unit. Method 1100 may be arranged in accordance with at least one embodiment described in the disclosure. Method 1100 may be performed, in some embodiments, by a device or system, such as system 100 of FIG. 1, system 300 of FIG. 3, system 400 of FIG. 4, system 500 of FIG. 5, system 600 of FIG. 6A and FIG. 6B, system 900 of FIG. 9, and/or system 1000 of FIG. 10, or another device or system. Although illustrated as discrete blocks, various blocks may be divided into additional blocks, combined into fewer blocks, or eliminated, depending on the desired implementation.

Method 1100 may begin at block 1102, wherein power is generated via a fuel cell generator positioned within a trailer box of a mobile surveillance unit, and method 1100 may proceed to block 1104. For example, power generator 320 (see FIG. 3), which may include a fuel cell generator, may be positioned within box 800 (see FIG. 8) of the mobile surveillance unit (e.g., mobile unit 1002 of FIG. 10) and may be configured to generate power.

At block 1104, at least some of the generated power may be provided to one or more devices of the mobile surveillance unit, and method 1100 may proceed to block 1106. For example, at least some of the generated power may be provided to one or more batteries (e.g., batteries 704 of FIGS. 7A and 7B), a controller (e.g., controller 302 of FIG. 3), an output device (e.g., lights, speakers, etc.), a sensor (e.g., a camera, microphone, weather sensor, etc.), another device, and/or any combination thereof.

At block 1106, a temperature proximate the fuel cell generator may be sensed, and method 1100 may proceed to block 1108. For example, a temperature sensor (e.g., temperature sensor 323 of FIG. 3) may sense the temperature near, around, and/or within the fuel cell generator. Further, for example, a signal indicative of the sensed temperature may be sent from the temperature sensor to a controller (e.g., controller 302 of FIG. 3). Further, for example, the controller may compare the sensed temperature to at least one predetermined threshold temperature (e.g., approximately 105 degrees Fahrenheit or any other temperature) or threshold temperature range (e.g., a range of approximately 102 degrees Fahrenheit to approximately 108 degrees Fahrenheit, or any other temperature range).

At block 1108, responsive to the sensed temperature being greater than or equal to a threshold temperature, a fan proximate the fuel cell generator may turn on to cause at least some air in the trailer box to exit the trailer box. For example, responsive to the sensed temperature being greater than or equal to a temperature of approximately 105 degrees Fahrenheit, the fan (e.g., fan 404 of FIG. 4 and/or fan 610 of FIGS. 6A and 6B) may be turned on. In some examples, a controller (e.g., controller 302 of FIG. 3) may convey one or more signals to a fan system (e.g., fan system 324 of FIG. 3) to cause an associated fan (e.g., fan 404 of FIG. 4 and/or fan 610 of FIGS. 6A and 6B) to turn on.

Modifications, additions, or omissions may be made to method 1100 without departing from the scope of the present disclosure. For example, the operations of method 1100 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, responsive to a sensed temperature being less than a temperature (e.g., the threshold temperature), the fan may be turned off (or a fan direction may be changed) (e.g., via one or more controls signals generated via a controller, such as controller 302 of FIG. 3).

As will be appreciated by persons having ordinary skill in the art, in contrast to conventional systems, which are configured to operate in only one temperature condition (i.e., either hot or cold), various embodiments may enable a device (e.g., a mobile unit), and more specifically, a power generator or a device, to operate in a range of extreme environments (e.g., hot conditions during summer months and cold/freezing conditions during winter months).

In accordance with common practice, the various features illustrated in the drawings may not be drawn to scale. The illustrations presented in the disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “approximately” or the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system including a mobile surveillance unit, the system comprising:
the mobile surveillance unit including:
at least one controller;
a fuel cell generator coupled to the controller;
a temperature sensor coupled to the at least one controller and configured for sensing a temperature adjacent the fuel cell generator; and
a fan system coupled to the at least one controller and including a fan positioned adjacent the fuel cell generator;
wherein the at least one controller is configured to:
receive a signal from the temperature sensor indicative of the sensed temperature; and
generate a control signal to turn the fan on based on the sensed temperature being greater than or equal to a threshold temperature.

2. The system of claim 1, wherein the fuel cell generator includes the temperature sensor.

3. The system of claim 1, wherein the threshold temperature comprises a temperature of approximately 105 degrees Fahrenheit.

4. The system of claim 1, wherein the threshold temperature comprises a temperature in the range of approximately 102 degrees Fahrenheit to approximately 108 degrees Fahrenheit.

5. The system of claim 1, wherein the mobile surveillance unit further comprises:
a box including the fuel cell generator and at least one battery; and
a head unit including the at least one controller, at least one sensor, and at least one output device.

6. The system of claim 1, wherein the mobile surveillance unit further comprises a box including the fuel cell generator, the temperature sensor, and at least one battery, wherein responsive to the fan being turned on, at least some air within the box is forced out of the box.

7. The system of claim 1, wherein the at least one controller is further configured to generate another, different control signal to turn the fan off based on the sensed temperature being less than the threshold temperature.

8. The system of claim 7, wherein the mobile surveillance unit further comprises a box including the fuel cell generator, the temperature regulator, and at least one battery, wherein responsive to the fan being turned off, at least some air within the box remains in the box.

9. The system of claim 1, wherein the mobile surveillance unit further comprises a housing including the fuel cell generator and the temperature regulator.

10. The system of claim 9, wherein the mobile surveillance unit further comprises a trailer and a box coupled to the trailer, the box comprising the housing, one or more batteries, and fuel for the fuel cell generator.

11. A method of operating a mobile surveillance unit, the method comprising:
generating power via a fuel cell generator coupled to a mobile surveillance unit and positioned with a trailer box of the mobile surveillance unit;
providing at least some of the generated power to one or more devices of the mobile surveillance unit;
sensing a temperature proximate the fuel cell generator; and
causing a fan proximate the fuel cell generator to turn on to cause at least some air in the trailer box to exit the trailer box responsive to the sensed temperature being greater than or equal to a threshold temperature.

12. The method of claim 11, wherein causing the fan to turn on comprises causing the fan to turn on responsive to the sensed temperature being greater than or equal to approximately 105 degrees Fahrenheit.

13. The method of claim 11, further comprising responsive to the sensed temperature being less than the threshold temperature, causing the fan to turn off such that at least some air within the trailer box remains in the trailer box.

14. The method of claim 11, wherein causing the fan to turn off comprises causing the fan to turn off responsive to the sensed temperature being less than approximately 105 degrees Fahrenheit.

15. The method of claim 11, further comprising comparing the sensed temperature to the threshold temperature.

16. A mobile surveillance unit, comprising:
a trailer;
a mast coupled to the trailer;
a head unit coupled to the mast and including a controller, a number of sensors, and a number of output devices; and
a storage box coupled to the trailer and including:
at least one battery;
a fuel cell generator;
a temperature regulator adjacent the fuel cell generator and including:
a temperature sensor coupled to the controller and configured for sensing a temperature proximate the fuel cell generator; and
a fan system including a fan;
wherein the controller is configured to:
receive a signal from the temperature sensor indicative of the sensed temperature; and
generate a control signal to control operation of the fan system based on the sensed temperature being greater than or equal to a threshold temperature.

17. The mobile surveillance unit of claim 16, further comprising a temperature regulator positioned adjacent the fuel cell generator and including the temperature sensor and the fan system.

18. The mobile surveillance unit of claim 16, wherein the fan system includes a housing at least partially around the fan, the housing positioned adjacent to the fuel cell generator.

19. The mobile surveillance unit of claim 16, wherein the fuel cell generator includes the temperature sensor.

20. The mobile surveillance unit of claim 16, wherein the controller is configured to:
compare the sensed temperature to the threshold temperature; and
convey the control signal to the fan system to turn the fan on responsive to the sensed temperature being greater than or equal to a threshold temperature.
